(19) United States
(12) Patent Application Publication
(10) Pub. No.: US 2023/0202030 A1
(43) Pub. Date: Jun. 29, 2023

(54) WORK SYSTEM, MACHINE LEARNING DEVICE, AND MACHINE LEARNING METHOD

(71) Applicant: Kabushiki Kaisha Yaskawa Denki, Kitakyushu-shi (JP)

(72) Inventors: Ryo MASUMURA, Kitakyushu-shi (JP); Wataru WATANABE, Kitakyushu-shi (JP)

(73) Assignee: Kabushiki Kaisha Yaskawa Denki, Kitakyushu-shi (JP)

(21) Appl. No.: 18/175,660

(22) Filed: Feb. 28, 2023

Related U.S. Application Data
(63) Continuation of application No. PCT/JP2021/031526, filed on Aug. 27, 2021.

(30) Foreign Application Priority Data
Aug. 28, 2020 (JP) 2020-144983

(51) Int. Cl. B25J 9/16; B25J 19/02; G06V 10/82; G06V 10/764; G06T 7/70; G06T 7/11

(52) U.S. Cl. CPC B25J 9/161; B25J 9/163; B25J 9/1697; B25J 19/023; G06V 10/82; G06V 10/764; G06T 7/70; G06T 7/11; G06V 2201/06; G06T 2207/20081; G06T 2207/20084

(57) ABSTRACT

Provided is a work system including: an object imaging unit configured to acquire an object image by photographing an object from a work direction; a work position acquisition unit configured to acquire a work position based on an existence region of the object obtained from a machine learning model; and a work unit configured to execute work on the object based on a work position obtained by inputting the object image to the work position acquisition unit.

### CROSS-REFERENCE TO RELATED APPLICATION

The present disclosure contains subject matter related to that disclosed in International Patent Application PCT/JP2021/031526 filed in the Japan Patent Office as a Receiving Office on Aug. 27, 2021, the entire contents of which are hereby incorporated by reference.

### BACKGROUND OF THE INVENTION

### 1. Field of the Invention

The present invention relates to a work system, a machine learning device, a work method, and a machine learning method.

### 2. Description of the Related Art

In Non Patent Literature, Kaiming He, Geogia Gkioxari, Piotr Dollar, Ross Girshick, “Mask R-CNN,” [online], Jan. 24, 2018, arXiv, [retrieved on Jul. 16, 2020], through the Internet at <https://arxiv.org/pdf/1703.06870.pdf>, there is described Mask R-CNN as a machine learning model for discriminating, from a photographic image, a region in which a specific object exists and a class of that region. Mask R-CNN is one of the machine learning models that implement what is called instance segmentation. With an instance segmentation architecture, while a rectangular region is obtained as an existence region of the object in Faster R-CNN, which has previously been used for object detection in images, a shape (segment) in the image of the object (instance) itself in the image is obtained. In addition, the extraction processing for the segment (segmentation) is performed not on all pixels of the image, but only on the rectangular region detected as the existence region of the object, and thus Mask R-CNN is considered to be advantageous in terms of computation speed as well.

### SUMMARY OF THE INVENTION

According to one aspect of the present invention, there is provided a work system including: an object imaging unit configured to acquire an object image by photographing an object from a work direction; a work position acquisition unit which includes a machine learning model, and is configured to acquire a work position based on a work region of the object obtained from the machine learning model; and a work unit configured to execute work on the object based on a work position obtained by inputting the object image to the work position acquisition unit, wherein the machine learning model is obtained by operating a computer to execute: arranging a virtual object in a virtual space; generating, in the virtual space, a virtual object image which is an image of the virtual object viewed from an imaging direction; generating, based on information on the virtual object in the virtual space, an image indicating a work region of the virtual object viewed from the imaging direction; and learning the work region of the virtual object in the virtual object image by using the virtual object image and the image indicating the work region.

Further, according to one aspect of the present invention, there is provided a machine learning device including a central processing unit and a memory which are configured to: arrange a virtual object in a virtual space; generate, in the virtual space, a virtual object image which is an image of the virtual object viewed from an imaging direction; generate, based on information on the virtual object in the virtual space, an image indicating a work region of the virtual object viewed from the imaging direction; and cause a machine learning model to learn the work region of the virtual object in the virtual object image by using the virtual object image and the image indicating the work region.

Further, according to one aspect of the present invention, there is provided a work method including: acquiring an object image by photographing an object from a work direction; acquiring a work region of the object by inputting the object image to a machine learning model; acquiring a work position based on the work region of the object; and executing work on the object based on the work position, wherein the machine learning model is obtained by operating a computer to execute: arranging a virtual object in a virtual space; generating, in the virtual space, a virtual object image which is an image of the virtual object viewed from an imaging direction; generating, based on information on the virtual object in the virtual space, an image indicating a work region of the virtual object viewed from the imaging direction; and learning the work region of the virtual object by using the virtual object image and the image indicating the work region.

Further, according to one aspect of the present invention, there is provided a machine learning method of causing a computer to execute: arranging virtual objects in a virtual space; generating, in the virtual space, a virtual object image which is an image of the virtual objects viewed from an imaging direction; generating, based on information on each of the virtual objects, an image indicating a work region of each of the virtual objects viewed from the imaging direction; and causing a machine learning model to learn an existence region of at least one of the virtual objects by using the virtual object image and the image indicating the work region.

### BRIEF DESCRIPTION OF THE DRAWINGS

FIG. 1 is a functional block diagram for illustrating an overall configuration of a machine learning device and a work system according to an embodiment of the present invention.

FIG. 2 is a diagram for illustrating an example of a hardware configuration of a machine learning data generation device.

FIG. 3 is an outside view of the machine learning device and the work system relating to a specific example of work assumed in this embodiment.

FIG. 4 is a diagram for illustrating processing executed by a work position acquisition unit when a work position is acquired from an object image.

FIG. 5 is a diagram for illustrating processing executed by the machine learning device when learning data is automatically generated and learned.

FIG. 6 is a diagram for illustrating a configuration of a GAN.

FIG. 7 is a flow chart for illustrating an example of a flow for obtaining a trained instance segmentation model that can be used in an engineering manner.

FIG. 8 is a flow chart for illustrating an example of a work flow.

FIG. 9 is a functional block diagram for illustrating an overall configuration of a machine learning device and a work system according to a modification example of the present invention.

FIG. 10 is a diagram for illustrating processing executed by the machine learning device according to the modification example when learning data is automatically generated and learned.

FIG. 11 is a diagram for illustrating an example of a designated region set in a virtual object.

FIG. 12 is a diagram for illustrating a designated region set in advance for each virtual object arranged in a virtual space.

FIG. 13 is a diagram for illustrating processing executed by a work position acquisition unit in the modification example when a work position is acquired from an object image.

FIG. 14 is a diagram for illustrating processing of setting the designated region in the virtual object.

FIG. 15 is a diagram for illustrating a user interface used when the designated region is set in the virtual object.

### DESCRIPTION OF THE EMBODIMENTS

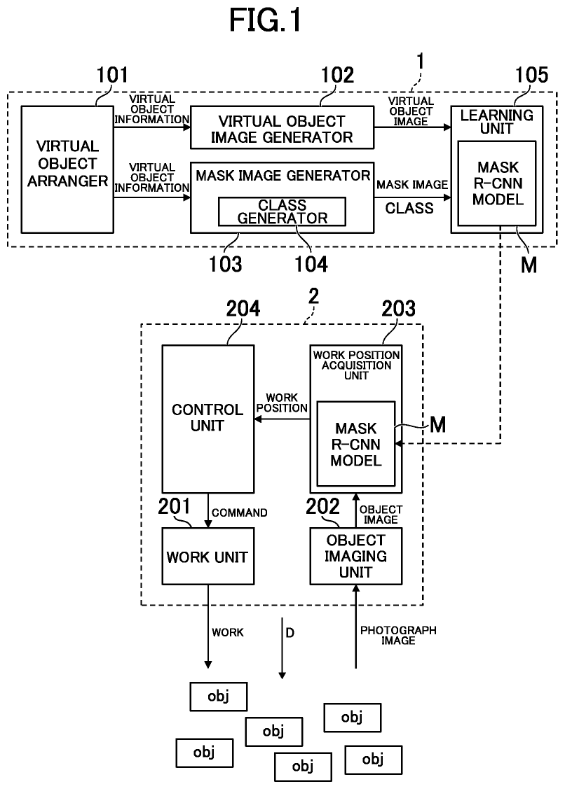

A work system, a machine learning device, a work method, and a machine learning method according to an embodiment of the present invention are now described with reference to FIG. 1 to FIG. 8.

FIG. 1 is a functional block diagram for illustrating an overall configuration of a machine learning device 1 and a work system 2 according to the embodiment of the present invention. The term “machine learning device” as used herein refers to a device which performs supervised learning with use of teacher data that is appropriate for a machine learning model, and the term “work system” as used herein refers to the entire control system which is built so as to execute desired work and which includes mechanisms that include various devices and control software.

In the drawings, the machine learning device 1 and the work system 2 are illustrated as independent devices, but the machine learning device 1 may be physically incorporated as a part of the work system 2. The machine learning device 1 may be built by being implemented by software with use of a general computer. Further, the work system 2 is not required to have all of its components arranged in a physically grouped place, and a part of those components, for example, a work position acquisition unit 203, which is described later, may be built on what is called a server computer, and only functions thereof may be provided to a remote site via a public telecommunications line, for example, the Internet.

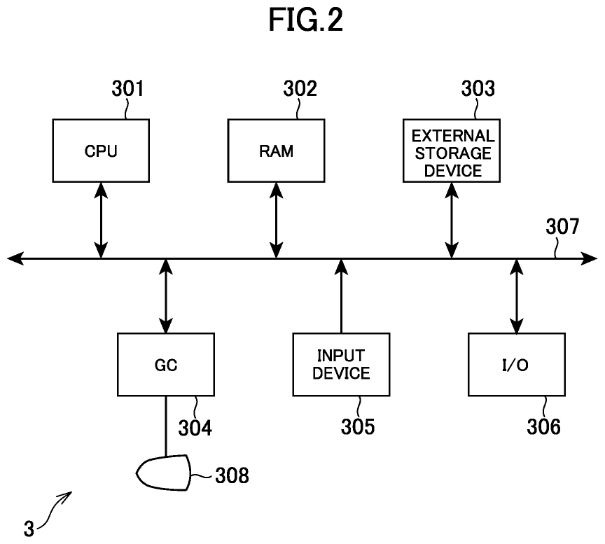

FIG. 2 is a diagram for illustrating an example of a hardware configuration of the machine learning device 1. The figure shows a general computer 3, in which a central processing unit (CPU) 301, which is a processor, a random access memory (RAM) 302, which is a memory, an external storage device 303, a graphics controller (GC) 304, an input device 305, and input/output (I/O) 306 are connected by a data bus 307 so that electric signals can be exchanged thereamong. The hardware configuration of the computer 3 described above is merely an example, and another configuration may be employed.

The external storage device 303 is a device in which information can be recorded statically, for example, a hard disk drive (HDD) or a solid state drive (SSD). Further, a signal from the GC 304 is output to a monitor 308, for example, a cathode ray tube (CRT) or what is called a flat panel display, on which a user visually recognizes an image, and the signal is displayed as an image. The input device 305 is one or a plurality of devices, for example, a keyboard, a mouse, and a touch panel, to be used by the user to input information, and the I/O 306 is one or a plurality of interfaces to be used by the computer 3 to exchange information with external devices. The I/O 306 may include various ports for wired connection, and a controller for wireless connection.

Computer programs for causing the computer 3 to function as the machine learning device 1 are stored in the external storage device 303, and are read out by the RAM 302 and executed by the CPU 301 as required. In other words, the RAM 302 stores codes for implementing various functions illustrated as the functional blocks in FIG. 1 by being executed by the CPU 301. Such computer programs may be provided by being recorded on an appropriate optical disc or magneto-optical disk, or an appropriate computer-readable information recording medium, for example, a flash memory, or may be provided via the I/O 306 through an external information communication line, for example, the Internet. When a part of the functional configuration of the work system 2 is implemented by a server computer installed at a remote site, the server computer to be used may be the general computer 3 illustrated in FIG. 2 or may be a computer having a configuration similar thereto.

Returning to FIG. 1, the machine learning device 1 includes, as its functional components, a virtual object arranger 101, a virtual object image generator 102, a mask image generator 103, a class generator 104, and a learning unit 105. In this example, the class generator 104 is implemented as a function accompanying the mask image generator 103, and thus the class generator 104 is illustrated as being included in the mask image generator 103. Further, the learning unit 105 holds a Mask R-CNN model M as an instance segmentation model to be machine-learned.

The work system 2 is an automatic machine system which executes predetermined work on an object that is the subject of the work from a work direction D by a work unit 201, and is built so as to be particularly suitable for cases in which a plurality of objects are stacked in bulk. The work system 2 includes, in addition to the work unit 201, an object imaging unit 202, the work position acquisition unit 203, and a control unit 204.

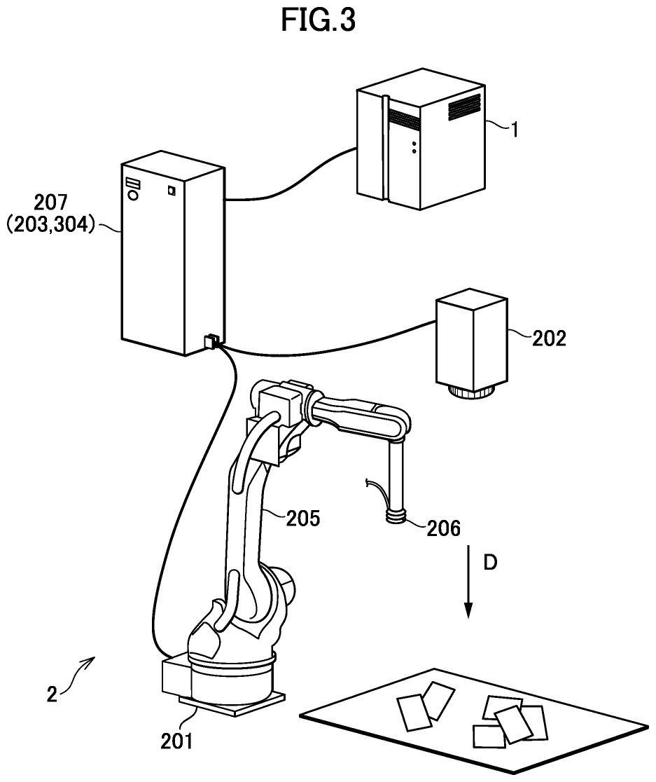

The term “work” as used herein has a feature in that the approach to the object by the work unit 201 is from the work direction D. However, the type of the work is not particularly limited, and there is no particular restriction on the type of application of the work system 2. For the purpose of facilitating understanding of the following description and from the point that the work can be particularly preferably implemented by the work system 2 that requires the configuration illustrated in FIG. 1, a specific example of the work which is assumed for the machine learning device 1 and the work system 2 according to this embodiment is illustrated in FIG. 3.

FIG. 3 is an outside view of the machine learning device 1 and the work system 2 relating to a specific example of the work assumed in this embodiment. In this example, the work system 2 is what is called a pick-up system, in which thin packages (for example, individually packaged film packages for liquid seasonings) that are irregularly stacked flat on a predetermined table or conveyor, and in some cases stacked in bulk in an overlapping manner, are individually suctioned and lifted from a vertical direction by a vacuum suction pad 206 arranged at the tip of a robot 205 and transported to a predetermined position. The robot 205 and the vacuum suction pad 206 provided as its hand are arranged in the work unit 201, and a two-dimensional camera is arranged as the object imaging unit 202 so as to photograph objects from the work direction D, in this case, the vertical direction. The work unit 201 and the object imaging unit 202 are connected to a robot controller 207, and the work position acquisition unit 203 and the control unit 204 are implemented as functions of the robot controller 207. In this example, the object to be the work subject is a thin package, and the work is the suctioning and transportation of the object.

In a case in which the work system 2 performs work on a plurality of bulk-stacked objects, as typified by such suction transport, a work position suitable for the work is required to be determined from the object image obtained by the object imaging unit 202, and the control unit 204 is required to issue appropriate operation commands to the work unit 201. At that time, in a case in which the determined work position is inappropriate, for example, when the object that is the work subject becomes snagged during the work because a part such as the edge of the object is on a lower side of another object, or when the surface of the object that is the work subject is inclined with respect to the work direction D in terms of its arrangement with other objects, the work may fail, causing problems such as stopping of the work system 2.

Thus, in the work system 2, the work position acquisition unit 203 which determines the work position from the object image includes a trained Mask R-CNN model M, and is configured to acquire the work position based on an existence region of the object that is the work subject obtained by inputting the object image to the R-CNN model M, and a class given to the existence region, and to output the acquired work position to the control unit 204.

In addition, when the work is picking, the same type of problem may be required to be taken into account on one level or another. When the picking method is vacuum suction as described in this embodiment, a work position that correctly indicates an appropriate target surface for suctioning the object is required. The same applies to various surface-holding methods in which an object is held by its surface other than by vacuum suction, for example, magnetic attraction and Bernoulli chuck. That is, the work system described in this embodiment is particularly suitable not only for picking by the vacuum suction described in the embodiment, but also for picking in general, particularly for work by surface holding. As a matter of course, the work may be work other than picking.

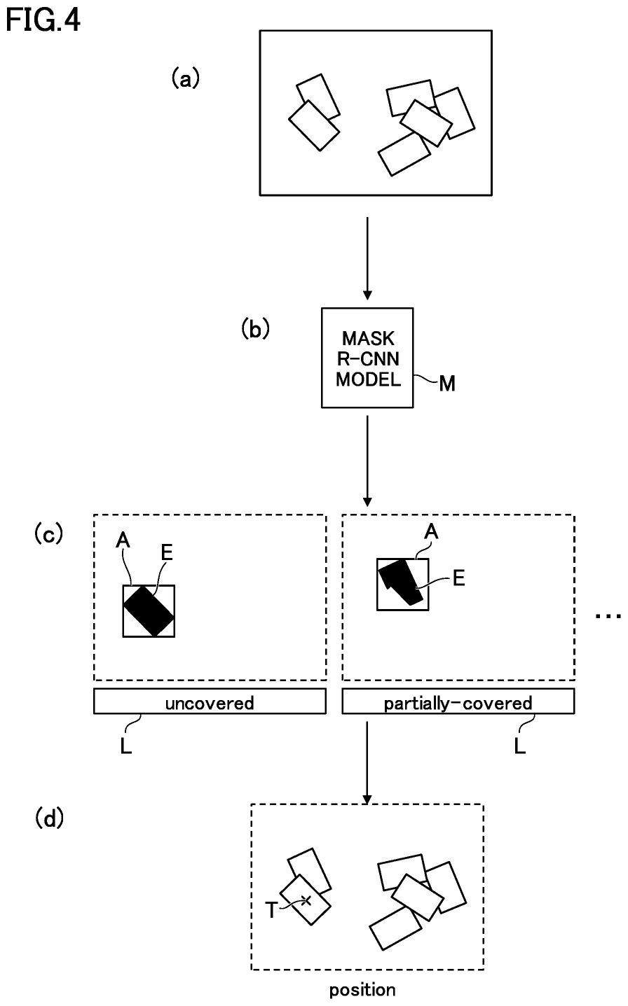

FIG. 4 is a diagram for illustrating processing executed by the work position acquisition unit 203 when a work position is acquired from an object image. First, (a) a plurality of objects are photographed from the work direction by the object imaging unit 202 to acquire an object image. Then, (b) the object image is optionally subjected to predetermined correction processing, for example, resolution, brightness, and contrast processing, and input to the Mask R-CNN model M. As a result, as illustrated in part (c), an existence region E of each of the plurality of objects and a label L are obtained.

The Mask R-CNN model M has been trained in advance so that when the object image, which is an image obtained by photographing objects stacked in bulk from the work direction, is received, the Mask R-CNN model M recognizes each object, and in the image, shows the pixels occupied by the recognized object, that is, the existence region E, as a segment and at the same time, output a label L indicating a coverage state of the recognized object by other objects, that is, whether or not the recognized object is covered by another object.

The Mask R-CNN model M is not required to output, as the output, an image of the same size as the input object image, and in the example illustrated in FIG. 4, a rectangular region A containing the existence region E and information indicating whether each pixel in the region A belongs to a segment are output so as to enable the existence region E to be grasped as a set of pixels belonging to the segment in the region A.

In this example, the training is carried out so that only two types of the label L are output, that is, “uncovered” indicating that the recognized object is not covered by another object, and “partially-covered” indicating that the recognized object is partially covered by another object. However, the training may also be carried out so as to output more detailed information, such as how much of the object is covered, the orientation of the object such as front and back, and, when there is a mixture of a plurality of types of objects, the types of those objects.

Then, as illustrated in part (d), the work position acquisition unit 203 acquires a work position T based on the existence region E and the class L of the obtained object. Specifically, among the recognized objects, the work position acquisition unit 203 identifies one object having the class L “uncovered” as a work subject, and determines the work position T from the existence region E of the identified one object by calculating, for example, the position of the center of gravity of the existence region E.

Through the above-mentioned processing, the work position acquisition unit 203 recognizes one object that is not covered by another object, acquires a position suitable for the work of the object as a work position, and outputs the position to the control unit 204. Thus, it can be expected that the work on the object can be successfully executed by the work unit 201 controlled based on the work position.

In the above description, the Mask R-CNN model M is trained to output a label L indicating the coverage state of the recognized object by another object, but the present invention is not limited to this. For example, regardless of whether or not a label L is output from the Mask R-CNN model M, the work position acquisition unit 203 may identify one object which is not covered by other objects as the work subject without using the label L. As a specific method of performing this, one object that is not covered by other objects can be identified based on at least one of the area or shape of the existence region E of the object recognized by the Mask R-CNN model M. The reason for this is because when the size of an object that is suitably arranged for the work is known in advance, and when the area of the existence region E is less than the true area of the object, it can be determined that the object is partially covered by another object or there is a problem with the orientation of the object. A similar determination can be made also when the outer shape of existence region E does not match the correct outer shape of the object that is suitably arranged for the work.

In order to train the Mask R-CNN model M to produce such an output, a general-purpose learning data library prepared for image recognition by general machine learning, for example, a COCO dataset used for the academic research of the above-mentioned Non Patent Literature 1, is completely unsuitable for a specific engineering application like that described in this embodiment, and cannot be used for the training.

That is, it is required to use a large amount of learning data that matches the assumed work, that is, learning data obtained by using the object that is the subject of the work which consists of a set of the object image illustrated in part (a) of FIG. 4, the mask image indicating the existence region E illustrated in part (c) of FIG. 4, and in some cases the label L attached to the mask image, and the learning data cannot be replaced by a general-purpose learning data library. This means that it is required to prepare dedicated learning data for each work and for each object. However, it is not realistic to manually create such dedicated learning data every time the work content changes and every time the object changes.

Thus, in this embodiment, the Mask R-CNN model M is trained by the machine learning device 1 without being always required to actually create the learning data manually. That is, instead of creating the learning data by using real objects, the machine learning device 1 automatically creates the learning data based on virtual objects arranged in a virtual space (hereafter referred to as “virtual objects”).

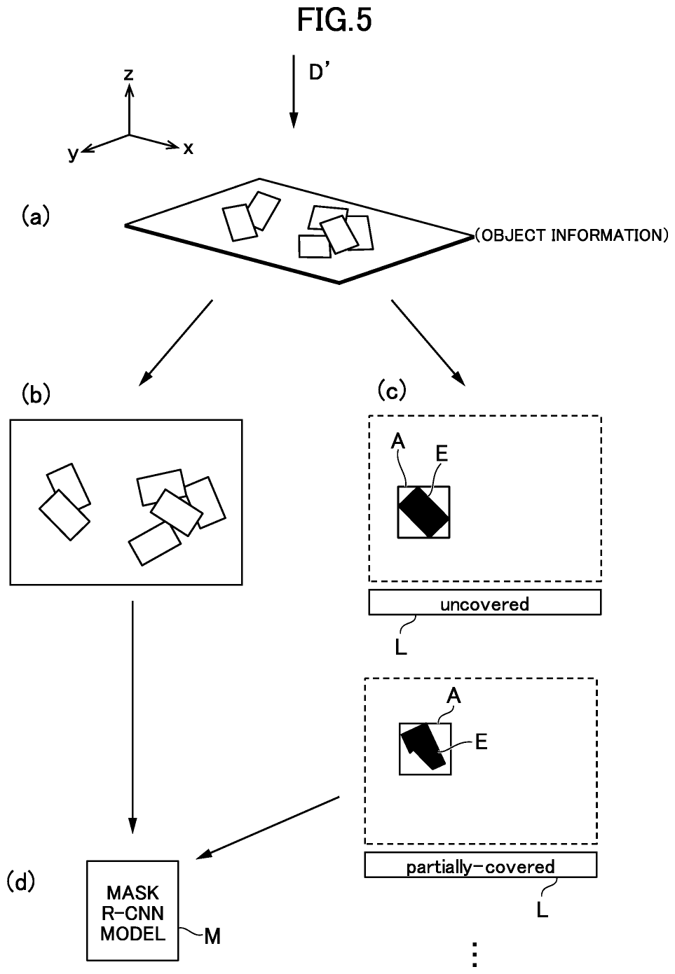

FIG. 5 is a diagram for illustrating processing executed by the machine learning device 1 when learning data is automatically generated and learned. First, as illustrated in part (a) of FIG. 5, the virtual object arranger 101 arranges a plurality of virtual objects in a virtual three-dimensional space. At this time, the virtual objects may be stacked in bulk in accordance with gravity such that the real objects are randomly arranged. The final positions of the plurality of objects may be determined by using a known physics engine. Parameters such as the shape and weight of each virtual object in the virtual space are determined in advance in accordance with the real objects. Depending on the circumstances, a simulation which considers deformation of the virtual objects may be performed.

In this way, object information on a plurality of objects is obtained. This object information is information including the position, orientation, and shape of each object arranged in the virtual three-dimensional space. Part (a) of FIG. 5 shows the object information, but the virtual object arranger 101 is not required to actually create 3D graphics as illustrated in part (a) of FIG. 5.

Then, or in parallel with part (c), which is described later, the virtual object image generator 102 generates a virtual object image, which is an image of the plurality of virtual objects viewed from an imaging direction D′, as illustrated in part (b). The imaging direction D′ illustrated in part (a) of FIG. 5 is a direction defined in the three-dimensional space so as to correspond to the imaging direction of the object imaging unit 202 in the real work system 2, which is indicated by the work direction D of FIG. 3. In this way, the virtual object image generator 102 generates, based on the object information, the virtual object image as if real objects were photographed.

Further, the virtual object image generator 102 not only generates an image of the plurality of virtual objects viewed from the imaging direction D′ from the object information by a so-called 3D graphics method, but the virtual object image generator 102 may also generate a virtual object image by further processing the obtained image as if the object image were photographed by the object imaging unit 202 in the real work system 2.

As a specific method, the virtual object image generator 102 may use a technology known as a generative adversarial network (GAN) to process the image generated by the 3D graphics method. The GAN itself is a known technique, and thus a description thereof is kept to a minimum in the following.

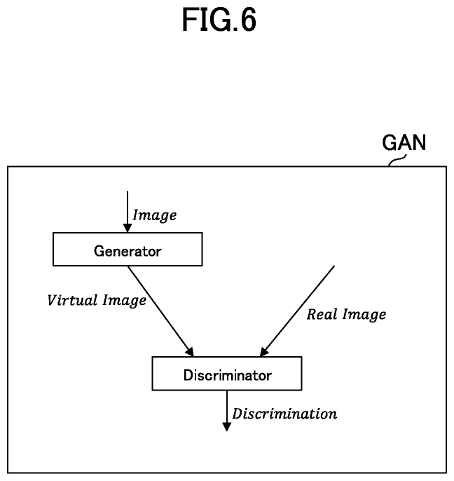

FIG. 6 is a diagram for illustrating a configuration of the GAN. As illustrated in FIG. 6, the GAN has two neural networks referred to as a generator and a discriminator. The image generated by the 3D graphics method from the object information is input to the generator to be processed by the generator, and a virtual image is output. Meanwhile, to the discriminator, both the virtual image output from the generator and the real image photographed by the actual object imaging unit 202 are input. At this time, the discriminator is not notified about whether the input image is the virtual image or the real image.

The output of the discriminator is to discriminate whether the input image is the virtual image or the real image. Then, in the GAN, reinforcement learning is performed repetitively for some virtual images and real images prepared in advance so that both are correctly discriminated in the discriminator and so that both cannot be discriminated by the discriminator in the generator.

This eventually results in a state in which both cannot be discriminated by the discriminator (for example, when the same number of virtual images and real images are prepared, an accuracy rate of 50%), and under such a state, it is considered that the generator outputs a virtual image that is indiscernible from the image photographed by the actual object imaging unit 202 and is as close as a real image, based on the image generated by the 3D graphics method. Consequently, in the virtual object image generator 102, the virtual object image may be generated by processing the image generated by the 3D graphics method with use of the generator that has been trained as described above.

Further, the virtual object image generator 102 is not always required to use the GAN, and may generate a virtual object image with use of known methods of computer graphics, for example, ray tracing and photorealistic rendering.

Further, following part (b) of FIG. 5 as described above, or in parallel therewith, as illustrated in part (c) of FIG. 5, the mask image generator 103 generates mask images viewed from the imaging direction D′ based on the object information on the plurality of virtual objects in the virtual three-dimensional space.

Each mask image indicates the existence region E of one or a plurality of specific virtual objects arranged in the virtual three-dimensional space, and at the same time, is an image corresponding to the virtual object image generated by the virtual object image generator 102.

First, regarding the point that each mask image indicates the existence region E of one or a plurality of specific virtual objects, this means that each mask image is an image that, as illustrated in part (c) of FIG. 5, fills in (that is, masks) the pixels in which the specific object of interest exists in the image (that is, a portion of the specific object appears in the image). For example, each mask image may be a binary image with the pixels in which the object exists being “1” and the pixels in which the object does not exist being “0”. The “1” and “0” may be reversed, or the mask image may be a grayscale image in accordance with the degree to which the object appears in the pixel. When the virtual object has been identified, the mask image can be easily obtained by a known 3D graphics method with use of the object information on the identified virtual object.

In addition, in the example described here, the Mask R-CNN is used for the instance segmentation model, and thus the mask image includes not only the existence region E but also the rectangular region A indicating a range in which the existence region E is included. The region A may be designated in accordance with the design of the instance segmentation model to be used. In this case, the center point, size, and aspect ratio of the region A are designated. However, the region A may not be required depending on the architecture of the instance segmentation model.

Next, regarding the point that each mask image is an image corresponding to the virtual object image generated by the virtual object image generator 102, this means that it is required to be able to know the existence region E of a specific object on the virtual object image by superimposing the mask image on the virtual object image. Thus, each mask image is what is called an alpha channel for the virtual object image. Consequently, the virtual object image and the mask image are required to have the same viewpoint position, projection direction, and screen position, for example, when the image is generated. Meanwhile, the resolution and the size of the images are not always required to match. The mask image may have a lower resolution than that of the virtual object image, and regarding the size, as long as the position at which the mask image corresponds to the virtual object image is clear, the mask image may be smaller than the virtual object image. In fact, in this embodiment, the mask image is an image having the region A as an outline, and thus the size of the mask image is different from the size of the virtual object image.

In part (c) of FIG. 5, the mask image generator 103 always identifies one virtual object and generates a mask image, but the mask image generator 103 may generate a mask image for a plurality of virtual objects. In that case, it is preferred to select a plurality of virtual objects having a common label, which is described later. Further, a plurality of mask images are normally generated, and in this embodiment, of the plurality of virtual objects arranged in the virtual three-dimensional space, mask images are generated for all virtual objects having at least a portion thereof appearing in the virtual object image. However, mask images may be generated only for some of the plurality of virtual objects arranged in the virtual three-dimensional space, for example, for the virtual objects positioned on an upper side.

Further, the class generator 104 of the mask image generator 103 simultaneously generates a class L for each generated mask image. In this embodiment, there are two types of the class L, that is, “uncovered” indicating that the virtual object serving as the subject of the mask image is not covered by another virtual object when viewed from the imaging direction D′, and “partially-covered” indicating that the virtual object is partially covered. However, as described above, more types of the class L may be generated. The class L can also be easily generated because it is possible to immediately discriminate the corresponding class L from the object information.

As illustrated in part (d), the machine learning device 1 uses a set of the virtual object image, the mask image, and the label obtained in this way as teacher data in the learning unit 105 to train the Mask R-CNN model M. This teacher data can be generated any number of times, and thus the training of the Mask R-CNN model M is executed, for example, a predetermined number of times (for example, 100,000 times), or until the inference by the Mask R-CNN model M reaches a predetermined evaluation. For example, the training may be repeatedly executed until an accuracy rate with respect to questions prepared in advance exceeds 99%.

In this way, by automatically training an instance segmentation model, such as the Mask R-CNN model M, with use of the machine learning device 1, it is not required to manually prepare a large amount of teacher data, and the instance segmentation model can be practically used in an engineering manner. Moreover, through use of the instance segmentation model trained in this way, the work system 2 can be built and operated in a practical manner.

In the above description of the machine learning device 1, it is assumed that the class L is generated for the mask image. However, in a case like that described above, in which the class L is not used and the work position acquisition unit 203 identifies one object not covered by another object as the work subject, the instance segmentation model does not require the class L as teacher data in training, and hence generation of the class L is not always required.

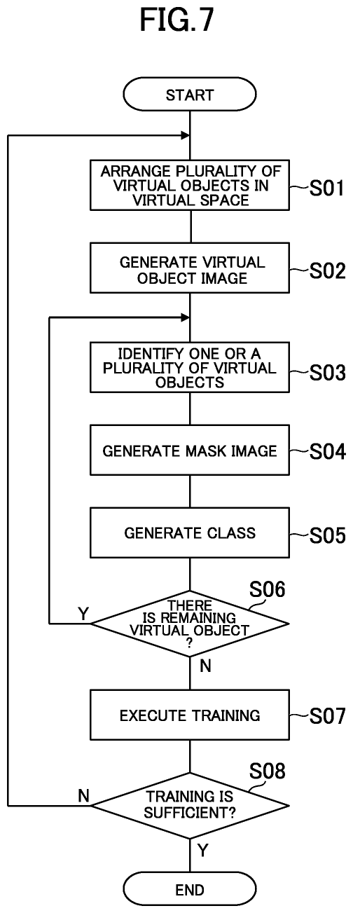

FIG. 7 is a flow chart for illustrating an example of a flow for obtaining a trained instance segmentation model that can be used in an engineering manner by the machine learning method described above.

First, the machine learning device 1 uses the virtual object arranger 101 to arrange a plurality of virtual objects in the virtual space (Step S01). Then, the machine learning device 1 uses the virtual object image generator 102 to generate a virtual object image (Step S02).

Subsequently, the mask image generator 103 identifies, from among the plurality of virtual objects, at least one virtual object that appears in the virtual object image (Step S03), and generates a mask image for the identified virtual object (Step S04). Further, the mask image generator 103 uses the class generator 104 to generate a class L for the identified virtual object (Step S05).

In addition, the mask image generator 103 discriminates whether or not, other than the virtual objects identified so far, there remains a virtual object for which a mask image and a class L are to be generated (Step S06). When a virtual object still remains, for example, when there exists a virtual object that appears in a virtual object image but for which the mask image and the class L have not yet been generated, the process returns to the step of identifying one or a plurality of virtual objects (Step S03), and repeats the processing until there are no more virtual objects for which the mask image and the class L are to be generated.

When sufficient mask images and classes L have been generated, the learning unit 105 trains the instance segmentation model (Step S07).

Then, it is determined whether or not the instance segmentation model has been sufficiently trained (Step S08). This determination may be performed, for example, based on whether or not the instance segmentation model has been trained a predetermined number of times, or whether or not the instance segmentation model has reached a predetermined evaluation through the training. The predetermined evaluation may be performed by executing an inference which uses the instance segmentation model on questions prepared in advance, and determining whether or not the accuracy rate thereof exceeds a predetermined threshold value.

When the training is still insufficient, the process returns to the step of arranging a plurality of virtual objects in the virtual space (Step S01), and repeats the processing until sufficient training is achieved. When the training is sufficient, a trained instance segmentation model that can be used in an engineering manner has been obtained, and hence the processing ends.

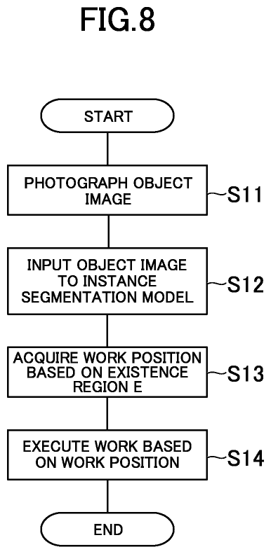

FIG. 8 is a flow chart for illustrating an example of a work flow by the work method described above.

First, the work system 2 photographs a plurality of objects from the work direction by using the object imaging unit 202 to acquire an object image (Step S11).

Then, the object image is input to the instance segmentation model by the work position acquisition unit 203 (Step S12). Here, the instance segmentation model is the trained instance segmentation model obtained by the method illustrated in FIG. 7.

The existence region of an object can be obtained from the instance segmentation model, and thus the work position acquisition unit 203 also acquires the work position based on the existence region of the object (Step S13). The work position may be acquired, for example, by calculating the position of the center of gravity of the existence region of the object.

Usually, the existence regions of a plurality of objects are obtained from the instance segmentation model, and thus the work position acquisition unit 203 identifies one object from among the plurality of objects as the work subject. The identification may be performed based on the class L which is output together with the existence region of the object from the instance segmentation model, or may be performed by detecting, based on at least one of the area or shape of the existence region of an object, that the object is not covered by another object.

The control unit 204 executes the work by controlling the work unit 201 based on the acquired work position (Step S14). As a result of this, one instance of the work ends, but in the case of repeatedly executing a plurality of instance of the work, the work method described above may be repeated as many times as required.

[Modification Example]

In the embodiment described above, the entire existence region of the object in the object image is recognized as the work region, and the work position is determined from the recognized work region. However, the user may set a designated region in the object in advance, and the region having the designated region in the object image may be recognized as the work region. In this case as well, the work position is determined from the recognized work region.

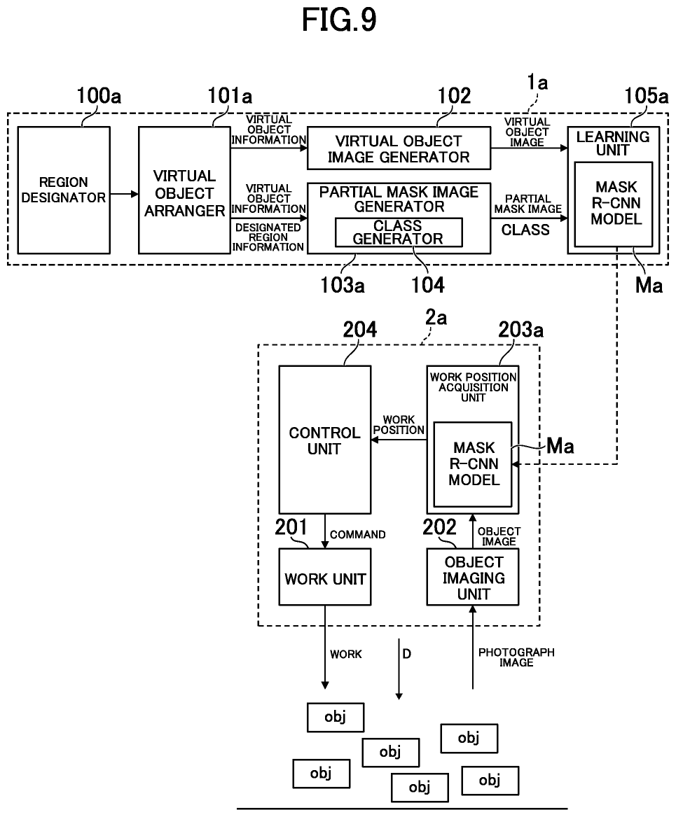

FIG. 9 is a functional block diagram for illustrating an overall configuration of a machine learning device and a work system according to a modification example of the present invention. FIG. 9 is mostly the same as FIG. 1, and hence like blocks are denoted by like reference symbols, and a detailed description thereof is omitted here. Further, blocks having partially common functions are denoted by reference symbols including the same numerals.

A machine learning device la according to the modification example includes a region designator 100a, a virtual object arranger 101a, a partial mask image generator 103a, and a learning unit 105a. Further, a work system 2a according to the modification example includes a work position acquisition unit 203a.

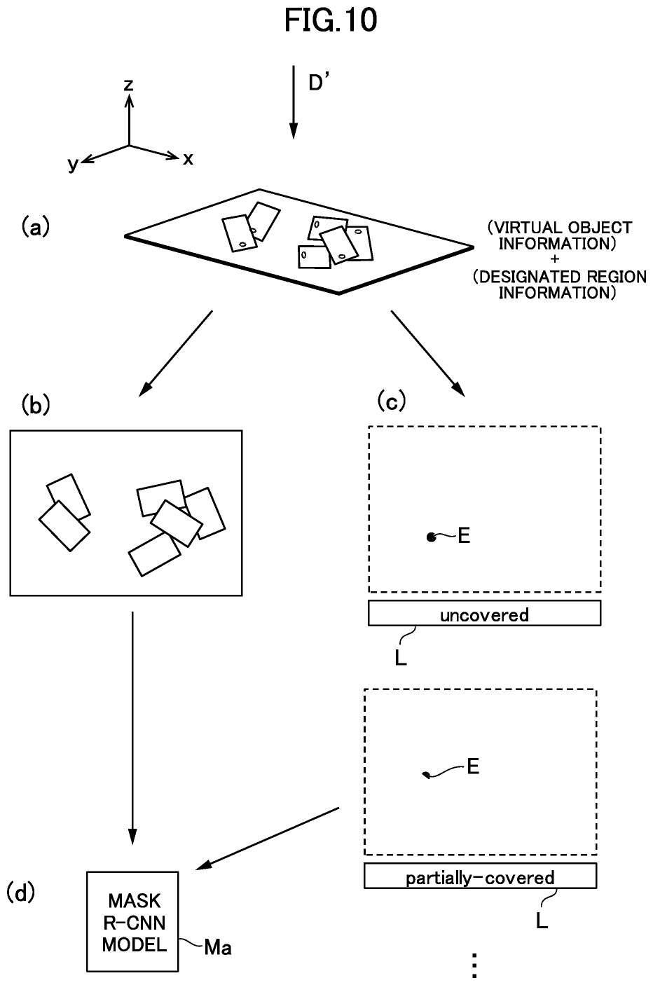

FIG. 10 is a diagram for illustrating processing executed by the machine learning device according to the modification example when learning data is automatically generated and learned. First, as illustrated in part (a) of FIG. 10, the virtual object arranger 101a arranges a plurality of virtual objects in the virtual three-dimensional space.

Then, or in parallel with part (c), which is described later, the virtual object image generator 102 renders a virtual object image, which is an image of the plurality of virtual objects viewed from the imaging direction D′, as illustrated in part (b).

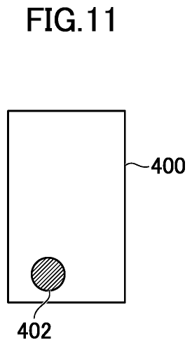

Further, following part (b) or in parallel therewith, as illustrated in part (c), the partial mask image generator 103a generates a partial mask image viewed from the imaging direction D′ based on designated region information on the plurality of virtual objects in the virtual three-dimensional space. That is, as exemplified in FIG. 11, a designated region 402 is set in advance in a virtual object 400. The designated region 402 is set in a portion of the surface of the virtual object 400, and the size, position, and shape of the designated region 402 may be freely set. When the user sets the designated region 402 in the virtual object 400 with use of the user interface provided by the region designator 100a, designated region information indicating the size, position and shape of the designated region 402 in the virtual object 400 is provided to the virtual object arranger 101a. The designated region information may indicate that a user-designated part of the polygons forming the virtual object 400 corresponds to the designated region 402. As another example, the designated region information may indicate a dummy object attached to the virtual object 400. The dummy object is arranged at a designated position in the virtual object 400 and has a designated size and a designated shape.

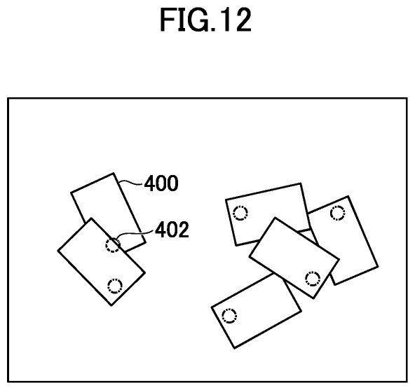

When the virtual object arranger 101a has arranged a plurality of the virtual objects 400 in the virtual three-dimensional space, as illustrated in FIG. 12, the designated region 402 set for each of those virtual objects 400 is also virtually arranged in the virtual three-dimensional space. Then, the partial mask image generator 103a renders partial mask images, which are images obtained by visualizing each designated region 402 from the imaging direction D′. In each partial mask image, a work region E is represented at the position of the designated region 402 viewed from the imaging direction D′. In each partial mask image, a specific pixel value is given to the pixels corresponding to the work region E, and a different pixel value is given to the other pixels. Further, the class generator 104 of the partial mask image generator 103a generates a class L for each partial mask image based on the virtual object information. The processing of part (a) to part (c) is repeatedly executed while changing the arrangement of each virtual object 400 in the virtual three-dimensional space, thereby obtaining a large number of sets of a virtual object image, partial mask images, and classes L.

As illustrated in part (d), the machine learning device la uses the sets of the virtual object image, the partial mask images, and the classes L obtained in this way as teacher data in the learning unit 105a to train a Mask R-CNN model Ma. The Mask R-CNN model Ma has the same architecture as that of the Mask R-CNN model M, but the teacher data used for learning is different, and thus the model is particularly referred to here as “Mask R-CNN model Ma.” As described above, it is not required that the teacher data of the Mask R-CNN model Ma include a class L. Further, the Mask R-CNN is generally used to recognize the entire existence region of an object, but in this modification example, the Mask R-CNN model Ma recognizes the designated region 402, which is a part of the existence region of the object.

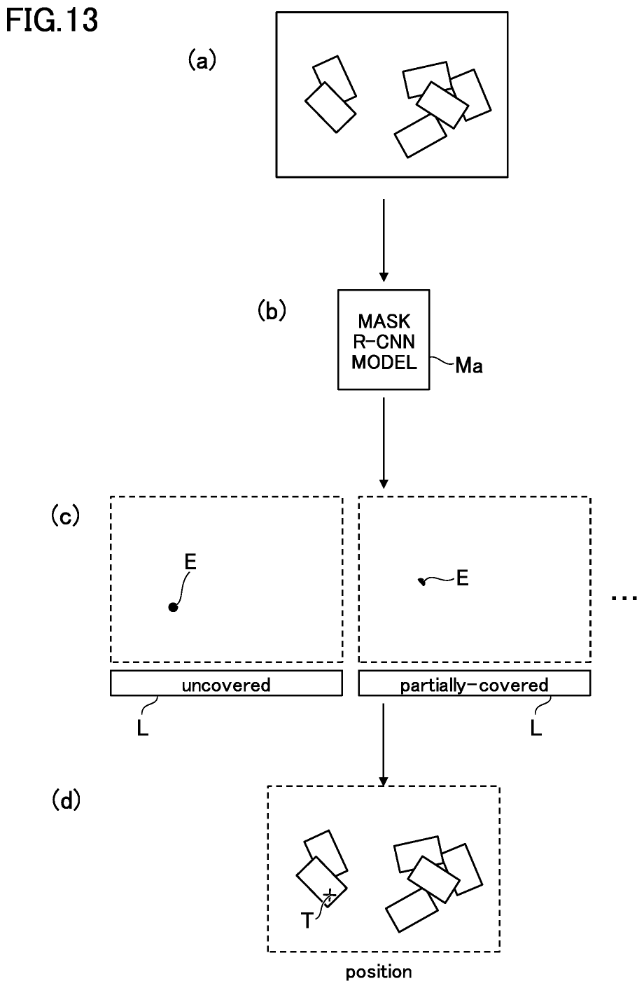

FIG. 13 is a diagram for illustrating processing executed by the work position acquisition unit 203a when a work position is acquired from an object image. First, (a) a plurality of objects are photographed from the work direction by the object imaging unit 202 to acquire an object image, and then (b) the object image is optionally subjected to predetermined correction processing, for example, resolution, brightness, and contrast processing, and input to the Mask R-CNN model Ma. As a result, as illustrated in part (c), a plurality of partial mask images and classes L are obtained.

As illustrated in part (d), the work position acquisition unit 203 acquires a work position T based on the work region E and the class L of the obtained object. Specifically, among the recognized objects, the work position acquisition unit 203 identifies one object having the class L “uncovered” as a work subject, and determines the work position T from the work region E of the identified one object by calculating, for example, the position of the center of gravity of the work region E. When there are a plurality of objects having “uncovered” as the class L, the object having the largest area of the work region E may be selected. As a result, it is possible to select an object facing the work direction, and to accurately perform work such as picking.

In the modification example, the work region E, which is a specific portion of the existence region of the object, is recognized in the object image by the Mask R-CNN model Ma, and the work position of the object is determined from the recognized work region E. Thus, work such as picking can be performed more accurately. In particular, when an object has a surface region that is not suitable for picking, for example, a curved surface, the work such as picking can be performed accurately by avoiding such a surface region and setting a designated region 402 at a portion suitable for the work.

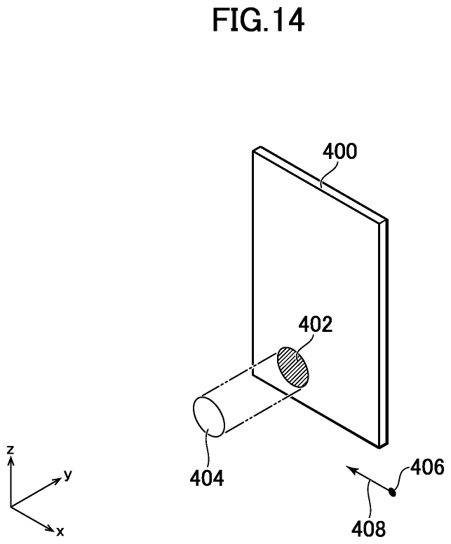

The processing of the region designator 100a is now described more specifically. The region designator 100a designates a partial region on the surface of the virtual object 400 as a designated region 402 via a predetermined user interface. As illustrated in FIG. 14, the region designator 100a arranges a virtual object 400 imitating the object to be the work subject in a virtual three-dimensional space. The region designator 100a further arranges a user interface object 404 in the same virtual three-dimensional space. The user interface object 404 is a flat plate-like object of any shape and size. In this example, a circular object is illustrated as the user interface object 404, but the shape may be changed to another shape, for example, a rectangle, in response to an instruction input with use of an input device such as a mouse or keyboard. As another example, the user may freely input a contour shape. Further, the size of the user interface object 404 may be changed in response to an instruction input with use of an input device.

Changes to the position and orientation of the user interface object 404 relative to the virtual object 400 are received from the user. For example, the position and orientation of the user interface object 404 in the virtual three-dimensional space are changed in response to an instruction input with use of an input device. The designated region 402 is generated by projecting the user interface object 404 onto the virtual object 400. For example, the designated region 402 is set on a portion of the surface of the virtual object 400 by parallel projection in a normal direction of the user interface object 404. The position, size and shape of the designated region 402 are calculated in real time to generate the designated region information.

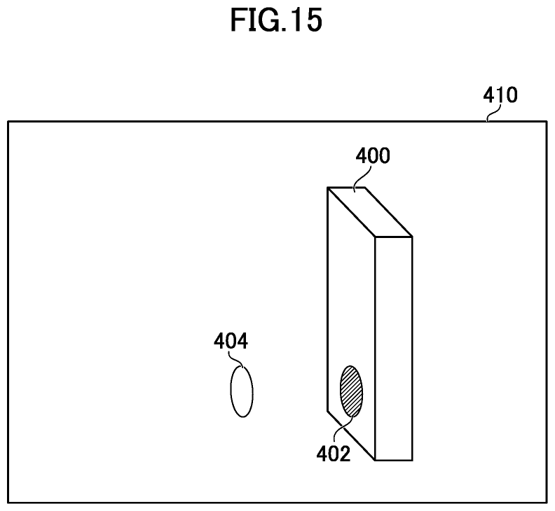

A viewpoint 406 and a line-of-sight direction 408 are set in the virtual three-dimensional space, and a view in the line-of-sight direction 408 from the viewpoint 406 is rendered in real time, thereby generating the user interface image 410 shown in FIG. 15. This user interface image 410 is displayed by the monitor 308. The viewpoint 406 and the line-of-sight direction 408 may also change in response to instructions input with use of an input device. The designated region 402 is also represented in the user interface image 410. The user can easily set the designated region 402 in the virtual object 400 by using such a user interface image 410.

While there have been described what are at present considered to be certain embodiments of the invention, it will be understood that various modifications may be made thereto, and it is intended that the appended claims cover all such modifications as fall within the true spirit and scope of the invention.

1. A work system, comprising:
an object imaging unit configured to acquire an object image by photographing an object from a work direction;
a work position acquisition unit which includes a machine learning model, and is configured to acquire a work position based on a work region of the object obtained from the machine learning model; and
a work unit configured to execute work on the object based on a work position obtained by inputting the object image to the work position acquisition unit,
wherein the machine learning model is obtained by operating a computer to execute:
arranging a virtual object in a virtual space;
generating, in the virtual space, a virtual object image which is an image of the virtual object viewed from an imaging direction;
generating, based on information on the virtual object in the virtual space, an image indicating a work region of the virtual object viewed from the imaging direction; and
learning the work region of the virtual object in the virtual object image by using the virtual object image and the image indicating the work region.

2. The work system according to claim 1,
wherein the object imaging unit is configured to photograph a plurality of the objects,
wherein a plurality of the virtual objects is arranged in the virtual space, and
wherein the work position acquisition unit is configured to identify, based on at least one of an area or a shape of the work region of each of the objects obtained from the machine learning model, one object for which the work region is not covered by another object when viewed from the work direction as a work subject, and to acquire the work position for the identified one object.

3. The work system according to claim 1,
wherein the object imaging unit is configured to photograph a plurality of the objects,
wherein a plurality of the virtual objects is arranged in the virtual space,
wherein the machine learning model is obtained by operating the computer to execute:
generating a class related to a coverage state of the virtual object by another virtual object; and
using the class to cause the machine learning model to learn the work region and class of the virtual object in the virtual object image, and
wherein the work position acquisition unit is configured to identify, based on a class obtained from the machine learning model, one object not covered by another object when viewed from the work direction as a work subject, and to acquire the work position for the identified one object.

4. The work system according to claim 1, wherein the work is picking of the object.

5. The work system according to claim 4, wherein the picking is performed by holding a surface of the object.

6. The work system according to claim 1, wherein the machine learning model is an instance segmentation model.

7. The work system according to claim 6, wherein the instance segmentation model is Mask R-CNN.

8. The work system according to claim 1, wherein the image indicating the work region is a mask image indicating an existence region of the virtual object when viewed from the imaging direction and corresponding to the virtual object image.

9. The work system according to claim 6, wherein the image indicating the work region is a mask image indicating an existence region of the virtual object when viewed from the imaging direction and corresponding to the virtual object image.

10. The work system according to claim 9,
wherein the object imaging unit is configured to photograph a plurality of the objects,
wherein a plurality of the virtual objects is arranged in the virtual space,
wherein a virtual object image is the image of the plurality of the virtual objects, and
wherein the mask image indicates the existence region of at least one virtual object involved in the plurality of the virtual object, based on the information on the plurality of the virtual object.

11. The work system according to claim 1, wherein the image indicating the work region indicates, when viewed from the imaging direction, a designated region designated in advance in a part of the virtual object.

12. The work system according to claim 11, wherein the machine learning model is obtained by operating the computer to execute:
arranging the virtual object in the virtual space;
generating, in the virtual space, the virtual object image which is an image of the virtual object viewed from the imaging direction;
generating, based on information on the designated region of the virtual object in the virtual space, an image indicating the work region of the virtual object viewed from the imaging direction; and
learning the work region of the virtual object in the virtual object image by using the virtual object image and the image indicating the work region.

13. The work system according to claim 2, wherein the image indicating the work region indicates, when viewed from the imaging direction, a designated region designated in advance in a part of the virtual object.

14. The work system according to claim 13, wherein the machine learning model is obtained by operating the computer to execute:
arranging the virtual object in the virtual space;
generating, in the virtual space, the virtual object image which is an image of the virtual object viewed from the imaging direction;
generating, based on information on the designated region of the virtual object in the virtual space, an image indicating the work region of the virtual object viewed from the imaging direction; and
learning the work region of the virtual object in the virtual object image by using the virtual object image and the image indicating the work region.

15. The work system according to claim 3, wherein the image indicating the work region indicates, when viewed from the imaging direction, a designated region designated in advance in a part of the virtual object.

16. The work system according to claim 15, wherein the machine learning model is obtained by operating the computer to execute:
arranging the virtual object in the virtual space;
generating, in the virtual space, the virtual object image which is an image of the virtual object viewed from the imaging direction;
generating, based on information on the designated region of the virtual object in the virtual space, an image indicating the work region of the virtual object viewed from the imaging direction; and
learning the work region of the virtual object in the virtual object image by using the virtual object image and the image indicating the work region.

17. The work system according to claim 11, further comprising a region designator configured to operate the computer to execute:
arranging a user interface object in the virtual space together with the virtual object;
receiving from a user a change in a position of the user interface object relative to the virtual object; and
identifying the designated region by projecting the user interface object onto the virtual object.

18. The work system according to claim 12, further comprising a region designator configured to operate the computer to execute:
arranging a user interface object in the virtual space together with the virtual object;
receiving from a user a change in a position of the user interface object relative to the virtual object; and
identifying the designated region by projecting the user interface object onto the virtual object.

19. A machine learning device, comprising a central processing unit and a memory which are configured to:
arrange a virtual object in a virtual space;
generate, in the virtual space, a virtual object image which is an image of the virtual object viewed from an imaging direction;
generate, based on information on the virtual object in the virtual space, an image indicating a work region of the virtual object viewed from the imaging direction; and
cause a machine learning model to learn the work region of the virtual object in the virtual object image by using the virtual object image and the image indicating the work region.

20. A machine learning method of causing a computer to execute:
arranging virtual objects in a virtual space;
generating, in the virtual space, a virtual object image which is an image of the virtual objects viewed from an imaging direction;
generating, based on information on each of the virtual objects, an image indicating a work region of each of the virtual objects viewed from the imaging direction; and
causing a machine learning model to learn an existence region of at least one of the virtual objects by using the virtual object image and the image indicating the work region.
